(19) United States
(12) Patent Application Publication
(10) Pub. No.: US 2009/0114744 A1
(43) Pub. Date: May 7, 2009

(54) Device for the Injection of Fuel Into the Combustion Chamber of an Internal Combustion Engine

(76) Inventors: Martin Bernhaupt, Oberalm (AT); Heinrich Werger, Golling (AT)

Correspondence Address: FITCH, EVEN, TABIN & FLANNERY, P. O. BOX 18415, WASHINGTON, DC, 20036, US

(21) Appl. No.: 12/083,076

(22) PCT Filed: Aug. 23, 2006
(86) PCT No.: PCT/AT2006/000349

§ 371 Date: Apr. 3, 2008

(30) Foreign Application Priority Data
Oct. 3, 2005 (AT) A 1613/2005

(51) Int. Cl. B05B 1/30

(52) U.S. Cl. 239/584

(57) ABSTRACT

In a device for the injection of fuel into the combustion chamber of an internal combustion engine, including an injector nozzle and a nozzle needle guided in a longitudinally displaceable manner within the injector nozzle for selectively releasing and blocking the fuel flow to the injection openings, the nozzle needle is at least partially surrounded by a nozzle prechamber, wherein a control element determining a supply cross-section for the fuel flow to the injection openings is arranged in the nozzle prechamber.

The invention relates to a device for the injection of fuel into the combustion chamber of an internal combustion engine, including an injector nozzle and a nozzle needle guided in a longitudinally displaceable manner within the injector nozzle for selectively releasing and blocking the fuel flow to the injection openings, said nozzle needle being at least partially surrounded by a nozzle prechamber.

Devices of this type, which are also referred to as injectors, are frequently used for common-rail systems to inject diesel fuels into the combustion chambers of diesel engines and are usually configured in a manner that the opening and closing of the injection cross-sections are performed by a nozzle needle that is guided by a shank in a longitudinally displaceable manner within a nozzle body. The control of the movement of the nozzle needle is realized via a solenoid valve. The nozzle needle is pressurized on both sides with the fuel pressure, and by a pressure spring acting in the closing direction. On the rear side of the nozzle needle, i.e. on its side facing away from the nozzle needle seat, a control chamber is provided, in which fuel under pressure pressurizes the nozzle needle in the closing direction, thus pressing the nozzle needle onto the needle seat or valve seat respectively.

The control valve, which may for instance be designed as a solenoid valve, releases a discharge line leading away from the control chamber in order to cause a drop of the fuel pressure prevailing in the control chamber, whereupon the nozzle needle is lifted from its seat against the force of the spring due to the fuel pressure prevailing on the other side, thus releasing the passage of fuel to the injection openings. The opening speed of the nozzle needle is determined by the difference between the flow rate in the supply line to the control chamber and the flow rate in the discharge line from the control chamber, wherein a throttle is each arranged both in the supply and in the discharge lines to respectively determine said flow rates.

To optimize the combustion procedure, it is necessary to adapt the injection course, i.e. the course of the amount of fuel injected into the combustion chamber, as precisely as possible to the requirements of the engine over time. This is, in particular, feasible via a stepped injection, namely by injecting a small amount of fuel at a lower pressure in a first injection phase and causing the main amount to reach a combustion chamber at a higher pressure in a second phase. Combustion noises, the consumption of fuel as well as emissions can, thus, be reduced. In common-rail injection systems, a high-pressure pump generates a constant pressure in the fuel accumulator (rail) with the rail pressure being approximately constant during the injection procedure such that the injected amount of fuel can be selected proportionally to the operating time of the valve within the injector and independently of the engine and pump speeds. It is thereby feasible to differently fix, and hence optimally adapt to the requirements of the engine, the beginning of injection and the duration of injection for different operating points of the engine. The desired course of injection can in this case be provided by a multiple energization of the solenoid in a manner that optionally a small pre-injection amount, followed by the main injection amount and, if desired, also by a post-injection amount will be injected into the combustion chamber of the internal combustion engine.

For the intermittent supply of fuel-fluid mixtures into the combustion chambers of an internal combustion engine including a common-rail pressure accumulator, an injector has already been described in DE 4425339 A1, wherein, in addition to a control chamber for controlling the longitudinal movements of the valve member between the valve member and the housing of the injection valve, a further control chamber is provided, which is formed between the valve member and a separate piston. From EP 1321662 A1, an injector including a valve needle can be taken, with a flow section being variable as a function of the stroke of the nozzle needle.

Common-rail injection systems are inter alia used for the injection of fuel having a high viscosity, a high portion of abrasively acting solids and a high temperature—so-called heavy oil—into the combustion chamber of an internal combustion engine. Heavy oil is, in particular, used as an energy carrier for engines having high cylinder outputs, the injectors used there yet having to be constructed for high injection amounts.

With high injection amounts as are necessary when using heavy oil, it is basically possible to influence the injection course as described above in a manner that the solenoid of the solenoid valve is energized and actuated several times during an injection procedure; yet, bearing in mind the high injection amounts, such a mode of operation will also involve high expenditures and the injector will be subject to high wear due to the impurities contained in heavy oil. Moreover, the interruption of the injection flow caused by the multiple energization of the solenoid will lead to that the high injection amounts required for the operation of large internal combustion engines will not be reached within the time window provided for the injection procedure.

The present invention, therefore, aims to improve the initially defined injection device and, in particular, render it suitable for use with heavy oil and in large internal combustion engines, while enabling the selective influence of the injection course.

To solve this object, the device of the initially defined kind is substantially characterized in that a control element determining a supply cross-section for the fuel flow to the injection openings is arranged in the nozzle prechamber. As opposed to the configurations according to the prior art, an influence of the fuel flow, and hence the injection course, will be reached not only by a multiple energization of the solenoid of the control valve, but also by the use of a separate control element directly in the nozzle prechamber. In doing so, the control element according to the invention will determine the supply cross-section for the fuel flow to the injection openings, with the fuel flow being controlled as a function of the desired course by the suitable adjustment of the control element.

The configuration according to the invention is preferably further developed such that the control element arranged in the nozzle prechamber is guided in a longitudinally displaceable manner, and that the supply cross-section is variable as a function of the stroke of the control element. The control element in this case is arranged in the nozzle prechamber in the manner of a valve so as to enable the control of the supply cross-section in a simple manner by the actuation of the control element in the longitudinal direction. In this respect, a configuration is of particular advantage, in which the control element shows a constant supply cross-section in its starting position so as to ensure a minimum flow without actuation of the control element, which can, for instance, be utilized for pre-injection. To this end, the configuration is preferably devised such that the control element comprises at least one bore having an effective supply cross-section in the starting position of the control element.

Departing from the minimum supply cross-section, which is independent of the position of the control element, the control of the supply cross-section is preferably effected in a manner that the supply cross-section is varied as a function of the stroke of the nozzle needle. To this end, the configuration is preferably devised such that means are provided for the adjustment of the control element as a function of the stroke of the nozzle needle.

The coupling of the stroke of the nozzle needle with the stroke of the control element in this case may, for instance, be realized in that the nozzle needle comprises a stop which cooperates with a counter-stop of the control element. The stop of the nozzle needle and the counter-stop of the control element in the closed position of the nozzle needle can be arranged in a spaced-apart relationship such that the nozzle needle will carry the control element along in the opening direction only after having travelled an empty run. As a result, the control element will remain in the closed position during the travel of a first partial stroke of the nozzle needle, and the nozzle needle will cooperate with the control element for changing the supply cross-section only during the travel of a further partial stroke. When passing the first partial stroke, merely the minimum supply cross-section of the control element, which is independent of the stroke of the control element, will be released so as to provide a first injection phase in which a small amount of fuel will be injected at a low pressure. It is only in the second phase that the supply cross-section released by the control element will be enlarged so as to allow for the injection of a main amount of fuel at a higher pressure into the combustion chamber.

The mechanical actuation of the control element by the cooperation of a stop of the nozzle needle with a counter-stop of the control element may be replaced with a hydraulic actuation. To this end, the configuration is advantageously further developed such that a control chamber controlling the opening and closing movements of the nozzle needle and capable of being filled with fuel, a further control chamber communicating with said control chamber, and a control element surface capable of being powered with the fuel pressure prevailing in said further control chamber are provided. The control chamber may be connected with the further control chamber via a bore provided in the nozzle needle, as will be explained in more detail below by way of the description of the Figures. Said further control chamber may be designed as an annular space provided between an annular step of the nozzle needle and an annular rim of the control element.

As already mentioned, the control element may be arranged in the nozzle prechamber in the manner of a valve-closing member, and in this respect it is preferably provided that the control element carries a conical seating surface and is pressable against a counter-seating surface of the injector nozzle by a power accumulator. The power accumulator may be designed as a helical compression spring supported on a shoulder of the nozzle needle and on an annular surface of the control element.

The control element is preferably formed by a sleeve surrounding the nozzle needle so as to ensure a particularly space-saving arrangement.

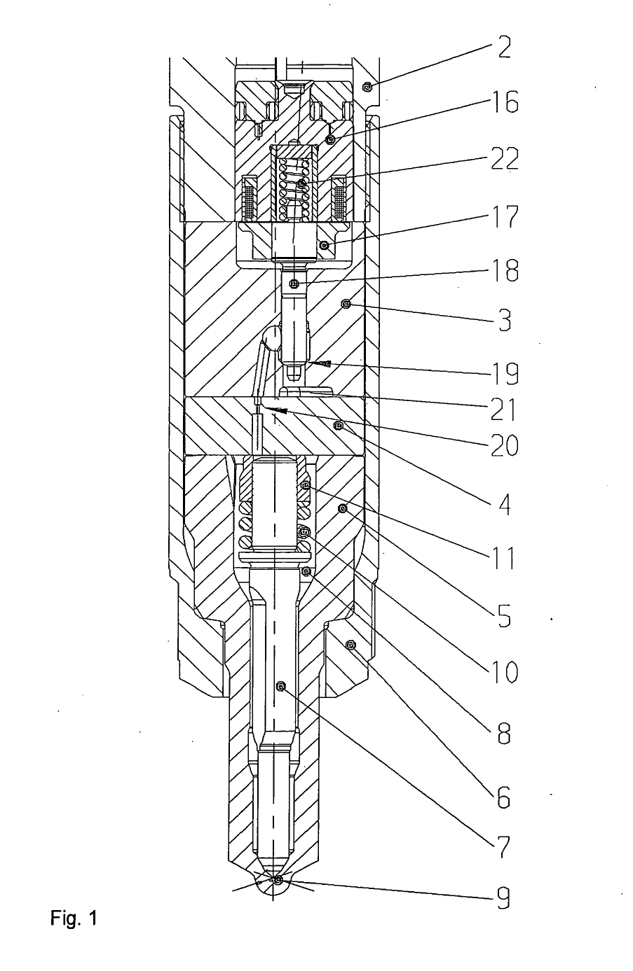

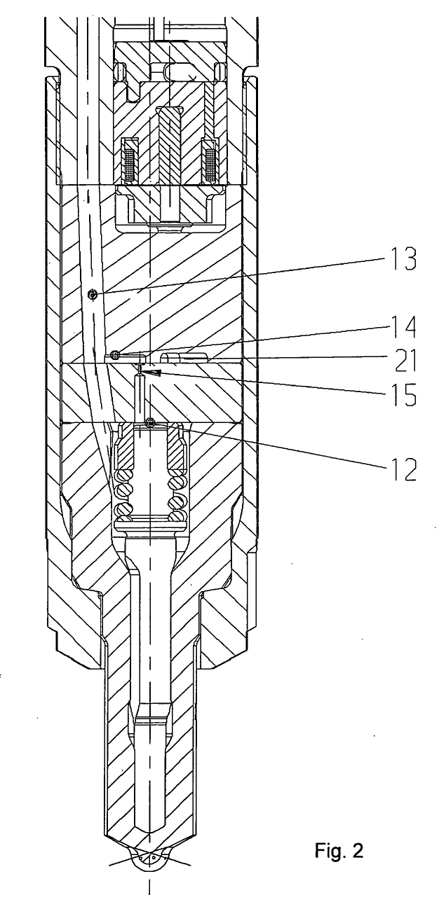

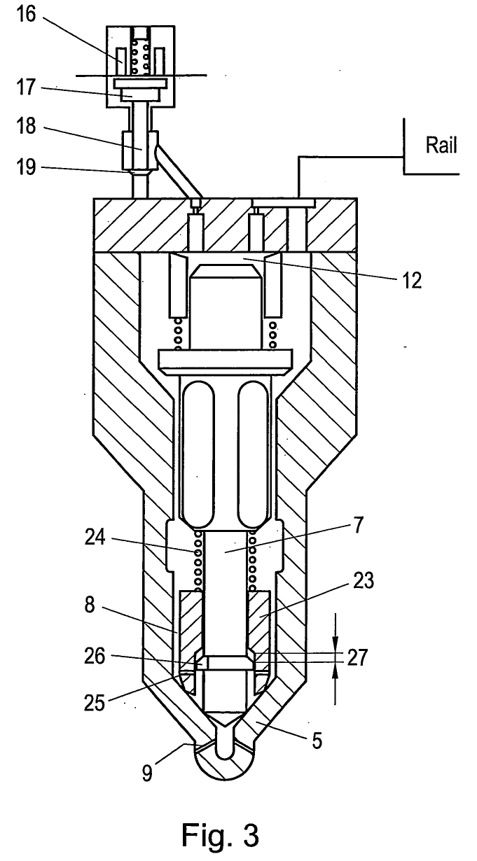

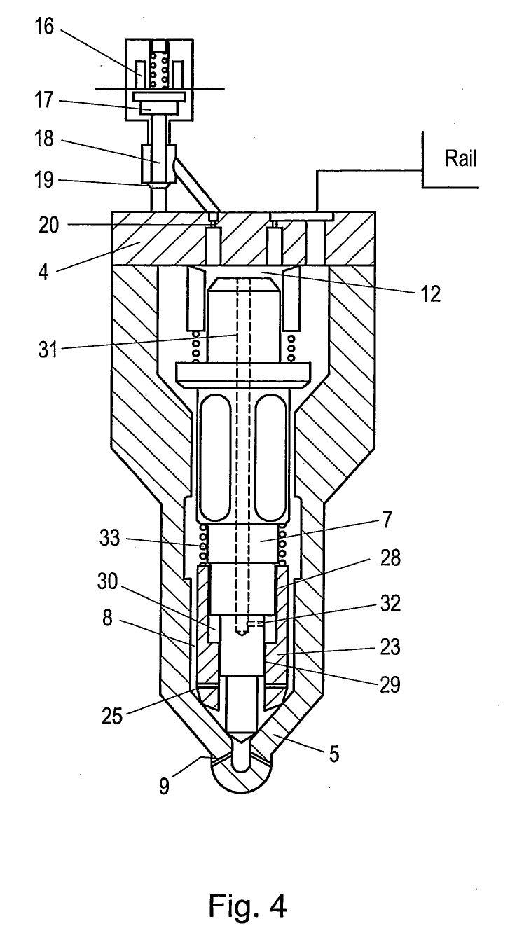

In the following, the invention will be explained in more detail by way of an exemplary embodiment schematically illustrated in the drawing. Therein, FIGS. 1 and 2 illustrate the basic setup of an injector for a common-rail injection system for large diesel engines; FIG. 3 depicts a first injector configuration according to the invention, which includes a control element designed as a sleeve; and FIG. 4 illustrates a modified configuration of the control element according to the invention.

FIGS. 1 and 2 depict an injector 1 comprising an injector body 2, a valve body 3, an intermediate plate 4 and an injector nozzle 5, which are held together by a nozzle clamping nut 6. The injector nozzle 5 comprises a nozzle needle 7, which is guided in a longitudinally displaceable manner within the nozzle body of the injector nozzle 5 and has several open spaces through which fuel can flow from the nozzle prechamber 8 to the tip of the needle. As the nozzle needle 7 performs an opening movement, fuel is being injected into the combustion chamber of the internal combustion engine through several injection openings 9.

The nozzle needle 7 comprises a collar to support a compression spring 10 which, by its upper end, presses a control sleeve 11 against the lower side of the intermediate plate 4. The control sleeve 11, the upper end face of the nozzle needle 7 and the lower side of the intermediate plate 4 delimit a control chamber 12. The pressure prevailing in the control chamber 12 is relevant to the control of the movement of the nozzle needle. Via the fuel supply bore 13, the fuel pressure, on the one hand, becomes effective in the nozzle prechamber 8, where it exerts a force in the opening direction of the nozzle needle 7 via the pressure shoulder of the nozzle needle 7. On the other hand, it acts in the control chamber 12 via a supply channel 14 and a supply throttle 15 and, assisted by the force of the pressure spring 10, holds the nozzle needle 7 in its closed position.

By activating the electromagnet 16, the solenoid armature 17 is lifted along with the valve needle 18 connected to it, and the valve seat 19 is opened. The fuel from the control chamber 12 flows through the discharge throttle 20 and the open valve seat 19 into the pressureless discharge channel 21 and, along with a drop of the hydraulic force exerted on the upper end face of the nozzle needle 7, results in the nozzle needle 7 being opened. The fuel will then reach the combustion chamber of the engine through the injection openings 9. In the opened state of the injector nozzle 5, high-pressure fuel flows into the control chamber 12 through the supply throttle 15 and, at the same time, in a larger amount, off through the discharge throttle 20. In doing so, the so-called control amount is pressurelessly discharged into the discharge channel 21, i.e. drawn off the rail in addition to the injection amount. The opening speed of the nozzle needle 7 is determined by the difference in the flow rates between the supply and discharge throttles 15, 20.

Upon completion of the activation of the electromagnet 16, the solenoid armature 17 is pressed downwards by the force of the pressure spring 22, and the valve needle 18 via the valve seat 19 closes the discharge path of the fuel through the discharge throttle 20. Via the supply throttle 15, the fuel pressure is again built up in the control chamber 12, generating a closing force that exceeds the hydraulic force exerted on the pressure shoulder of the nozzle needle 7, reduced by the force of the pressure spring 10. The nozzle needle 7 obstructs the path to the injection openings 9, thus and concluding the injection procedure.

The injector design represented in FIGS. 1 and 2 allows to influence the injection course by a multiple energization of the solenoid in a manner that optionally also a small pre-injection amount, followed by the main injection amount and optionally also a post-injection amount will be injected into the combustion chamber of the internal combustion engine. Yet, it does not allow for the realization of an injection course formation in a manner that different pressures depending on the needle stroke will become effective at the injection openings in a selective manner.

FIG. 3 depicts a first injector design which enables the formation of an injection course by injecting into the combustion chamber of the engine at first a pre-injection amount at a low conveying rate, followed by the main injection amount at a high conveying rate, and which is therefore suitable for operation with large injection amounts and, in particular, for heavy oil in common-rail systems.

This injector configuration comprises a control element 23 which is displaceably guided on the nozzle needle 7 and pressed against the seating cone in the lower region of the injector nozzle 5 by a compression spring 24 supported on a shoulder of the nozzle needle 7. The control element in this case is designed as a sleeve 23. As soon as the nozzle needle 7 is lifted off its conical seat in the injector nozzle 5 by lowering the fuel pressure in the control chamber 12, fuel will flow out of the nozzle prechamber 8 through one or more throttles 25 provided in the sleeve 23, at a pressure reduced by such throttling, to the injection openings 9 provided in the tip region of the injector nozzle 5. As long as the sleeve 23 still rests on the seating cone, the injection rate will remain low, with the supply cross-section released by the throttles 25 being initially uninfluenced by the stroke of the nozzle needle 7.

As soon as the nozzle needle 7 has carried out its pre-stroke 27 during the opening procedure, a stop designed as a drive ring 26 enters into contact with a counter-stop designed as a step on the sleeve 23, thus subsequently lifting the sleeve off the seating cone in the lower region of the injector nozzle 5. As a result, a large and unthrottled supply cross-section to the injection openings 9 is opened to the fuel in the nozzle prechamber 8 so as to enable the main injection at a high conveying rate.

To stop the injection procedure by fuel pressure building up in the control chamber 12, the sleeve 23 is displaced in the direction of the seating cone along with the nozzle needle 7. This will initially cause the sleeve 23 to be placed on the seating cone in the lower region of the injector nozzle 5, and, after having carried out the pre-stroke 27, the fuel path to the injection openings 9 will be blocked by the nozzle needle 7 being seated on its seat. The duration of a throttled injection during the closing procedure is only very short on account of the high speed of the nozzle needle 7 towards the end of the closing movement.

FIG. 4 illustrates a second injector configuration, in which the lifting of the sleeve is controlled hydraulically rather than mechanically as illustrated in FIG. 3. A sleeve 23 is displaceably guided on the nozzle needle 7 through two guiding diameters 28, 29. A sleeve control chamber 30 is thereby formed between the steps provided on the nozzle needle 7 and on the sleeve 23. The sleeve control chamber 30 communicates with the control chamber 12 above the nozzle needle 7 via the central bore 31 and the transverse bore 32. The sleeve 23 is pressed against the seating cone in the lower region of the injector nozzle 5 by the fuel pressure prevailing in the sleeve control chamber 30.

To initiate the injection procedure, the valve seat 19 is opened by the solenoid armature 17 of the 2/2-way valve. The pressure in the control chamber 12, thus, decreases with the nozzle needle 7 being lifted off its seat. The fuel flows from the nozzle prechamber 8 through one or several throttles 25 provided in the sleeve 23, at a pressure reduced by such throttling, to the injection openings 9 provided in the tip region of the injector nozzle. The abutment of the nozzle needle 7 on the lower side of the intermediate plate 4 by its upper end face causes the pressure within the control chamber 12 to drop strongly. This pressure drop is transmitted into the sleeve control chamber 30 via the central bore 31 and the transverse bore 32. The force caused by the fuel pressure from the nozzle prechamber 8 acting on the pressure stage of the sleeve will then exceed the forces caused by the pressures in the sleeve control chamber 30 and from the spring 33 and acting in the closing direction. The sleeve 23 is thereby forced to lift off the seating cone in the lower region of the injector nozzle 5 and to open a large and unthrottled supply cross-section from the nozzle prechamber 8 to the injection openings 9.

To terminate the injection procedure, the fuel pressure is again built up in the control chamber 12, also reaching the sleeve control chamber 30 through the central bore 31 and the transverse bores 32 upon lifting of the nozzle needle 7 off its stop on the lower side of the intermediate plate 4. The sleeve 23 is thereby displaced in the direction of the nozzle tip, reaching its closing position on the seating cone, as will the nozzle needle 7 shortly after this. The injection procedure is thereby completed.

The advantage of the described injector configuration resides in that the fuel paths for the main injection are conducted via large cross-sectional areas externally past the sleeves. These configurations are, therefore, particularly suitable for large injection amounts as are required for the injectors of large internal combustion engines.

1. A device for the injection of fuel into the combustion chamber of an internal combustion engine, including an injector nozzle and a nozzle needle guided in a longitudinally displaceable manner within the injector nozzle for selectively releasing and blocking the fuel flow to the injection openings, said nozzle needle being at least partially surrounded by a nozzle prechamber, wherein a control element determining a supply cross-section for the fuel flow to the injection openings is arranged in the nozzle prechamber.

2. A device according to claim 1, wherein the control element arranged in the nozzle prechamber is guided in a longitudinally displaceable manner, and that the supply cross-section is variable as a function of the stroke of the control element.

3. A device according to claim 1, wherein the control element comprises at least one bore having a supply cross-section that is independent of the position of the control element.

4. A device according to claim 1, wherein means are provided for the adjustment of the control element as a function of the stroke of the nozzle needle.

5. A device according to claim 1, wherein the control element remains in the closed position during the travel of a first partial stroke of the nozzle needle and is adjustable during the travel of a further partial stroke of the nozzle needle for changing the supply cross-section.

6. A device according to claim 4, wherein the means for adjusting the control element are comprised of a stop of the nozzle needle and a counter-stop for the control element.

7. A device according to claim 6, wherein the stop of the nozzle needle and the counter-stop of the control element in the closed position of the nozzle needle are arranged in a spaced-apart relationship such that the nozzle needle carries the control element (23) along in the opening direction after having travelled an empty run

8. A device according to claim 4, wherein the means for adjusting the control element comprise a control chamber controlling the opening and closing movements of the nozzle needle and capable of being filled with fuel, a further control chamber communicating with said control chamber, and a surface of the control element capable of being powered with the fuel pressure prevailing in said further control chamber.

9. A device according to claim 8, wherein said control chamber communicates with said further control chamber via bores of the nozzle needle.

10. A device according to claim 8, wherein said further control chamber is designed as an annular space provided between an annular step of the nozzle needle and an annular rim of the control element.

11. A device according to claim 1, wherein the control element carries a conical seating surface and is pressable against a counter-seating surface of the injector nozzle by a power accumulator.

12. A device according to claim 11, wherein the power accumulator is designed as a helical compression spring supported on a shoulder of the nozzle needle and on an annular surface of the control element.

13. A device according to claim 1, wherein the control element is formed by a sleeve surrounding the nozzle needle.
